(19) United States
(12) Patent Application Publication
(10) Pub. No.: US 2007/0177163 A1
(43) Pub. Date: Aug. 2, 2007

(54) METHOD OF AND DEVICE FOR THICKNESS MEASUREMENT OF THICK PETROCHEMICAL FILMS ON WATER SURFACE

(76) Inventors: Michael Leonidovich Belov, Moscow (RU); Victor Aleksandrovich Gorodnichev, Moscow (RU); Valentin Ivanovich Kozintsev, Moscow (RU); Yurii Victorovich Fedotov, Moscow (RU)

Correspondence Address: UNITED STATES DEPARTMENT OF ENERGY, 1000 INDEPENDENCE AVENUE, S.W., ATTN: GC-62 (HQ) MS 6F-067, WASHINGTON, DC, 20585-0162, US

(21) Appl. No.: 11/559,011

(22) Filed: Nov. 13, 2006

(30) Foreign Application Priority Data
Nov. 10, 2005 (RU) 2005134710

(51) Int. Cl. G01B 11/06

(52) U.S. Cl. 356/632

(57) ABSTRACT

A method of thickness measurements of thick petrochemical films on a water surface has includes irradiating a surface by an optical beam, receiving a reflected signal, analyzing the dependence of intensity of the reflected signal on a wavelength, determining a film thickness based on the analysis, using three wavelengths for irradiation of the surface, selecting the wavelengths from conditions

$$\frac{{n}_{2} {λ}_{1}}{{λ}_{2}} = 2 \frac{{n}_{2} ( {λ}_{2} )}{{λ}_{2}} ,$$

where n₂ (λ₁) and n₂(λ₂) are refraction coefficients of petrochemical product at the wavelengths: λ₁ and λ₂, λ₃ is equal to a wavelength of absorption maximum of petrochemical product, and using for the determination of the film thickness results of the analysis of intensity of the reflected signal at the three wavelengths.

### CROSS-REFERENCE TO A RELATED APPLIACTION

The invention described and claimed hereinbelow is also described in Russian Patent Application No. 2005134710 filed on Nov. 10, 2005. This Russian Patent Application, whose subject matter is incorporated here by reference, provides the basis for a claim of priority of invention under 35 U.S.C. 119(a)-(d).

### BACKGROUND OF THE INVENTION

The present invention relates to a method of and a device for measuring thick petrochemical films on a water surface.

More particularly, it relates to method and device for the above mentioned measurements of film thickness of oil spills on rivers, lacustrine and sea waters. Methods of the above mentioned general type are known in the art and disclosed for example in Japanese patent No. 3-57407, U.S. Pat. No. 4,605,349, patent of Russian Federation no. 2,168,151, patent of Russian Federation no. 2,207,501. In the above cited methods the film surface is irradiated by an optical beam, the radiation reflected from the surface is received, the dependence of the reflected signal intensity is measured as a function of a wavelength, and a film thickness is determined using the calculation results of distance between extremes, amount of extremes or parameters of approximation of dependence of the reflected signal intensity versus wavelength in a tuning range,

The known methods however possess a disadvantage in possible high measurement errors in the case of thick films, because of radiation attenuation in the film, especially in noise conditions. The noise conditions means internal noise of the measurement device and external noise, which lead to fluctuations of the received signals.

### SUMMARY OF THE INVENTION

Accordingly, it is an object of the present invention to provide a method of and device for measurement of thick petrochemical films on water surfaces, which eliminates the disadvantages of the prior art.

In keeping with these objects and with others which will become apparent hereinafter, one feature resides, briefly stated, in a method of thickness measurement of thick petrochemical films on a water surface, comprising the steps of irradiating a surface by an optical beam; receiving a reflected signal; analyzing a dependence of intensity of the reflected signal on a wavelength; determining a film thickness based on the analysis; using three wavelengths for irradiation of the surface λ₁, λ₂, λ₃ selected from the condition:

$$\frac{{n}_{2} ( {λ}_{1} )}{{λ}_{1}} = 2 \frac{{n}_{2} ( {λ}_{2} )}{{λ}_{2}} ,$$

where n₂ (λ₁), n₂ (λ₂) are coefficients of refraction of an oil product on the wavelengths λ₁, λ₂; and λ₃ is equal to a wavelength of maximum absorption of the oil product, and the determination of the film thickness is performed based on the analysis of intensity of the signal reflected from the surface at these three wavelengths.

Another feature, of the present, resides in a device for measuring thickness of thick petrochemical films on a water surface, comprising means for irradiation of surface by optical beam; means for receiving a reflected signal; means for analyzing a dependence of intensity of the reflected signal on a wavelength, means for determining a film thickness based on the analysis, wherein said means for irradiation of surface by optical beam is configured as a means for irradiation of surface with three wavelengths, so that said means for determining a film thickness determines the film thickness using the analysis of intensity of the reflected signal at the three wavelengths, wherein the wavelengths λ₁, λ₂, λ₃ are selected from said condition and

$$\frac{{n}_{2} ( {λ}_{1} )}{{λ}_{1}} = 2 \frac{{n}_{2} ( {λ}_{2} )}{{λ}_{2}}$$

where n₂ (λ₁), n₂ (λ₂)are coefficients of refraction to the end of the same statement.

When the method is performed and a device is designed in accordance with the present invention, the accuracy of the measurements are significantly increased.

The method and device in accordance with the present invention can be used for on-line detection, thickness measurement of oil pollution and mapping of oil pollution (for example from aircraft) of oil and petrochemical spills in sea and inland waters. The cause of the spills can be an oil tanker wreck, oil plant installation failure, oil filling station and oil-transfer failure, oil derrick failure on the continental shelf, underwater oil storage failure and oil pipeline failure. The thickness measurements of petrochemical films combined with oil pollution map allows volume estimation of spilled oil. This information allows necessary estimation means for the breakdown or malfunction of people, equipment, reagents, money, etc.

The method and device can be also used for continuous (using a stationary mounted device) or periodical (using a portable device) thickness measurement of petrochemical film in waste disposal plates and in water purification plates for quality control of disposal water.

Low-cost contact laser devices can be used for remote thickness measurement of thick oil and petrochemical films on water surface in accordance with the present invention. The proposed method and device can be modified for performing non-contact thickness measurement of all kinds of thick transparent films, for example for technological tasks.

The novel features of which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view schematically showing a device for thickness measurements of thick petrochemical films on water surfaces in accordance with the present invention; and

FIG. 2 is a view showing a relationship between a given film thickness and a found film thickness.

### DESCRIPTION OF THE PREFERRED EMBODIMENTS

In accordance with the present invention a method is proposed for measurements of thick petrochemical films on a water surface The method can operate in the case of thick petrochemical film when transmission of film is essentially differing from 1. The method includes irradiation of surface by optical beam, reception of reflected signal and analysis of dependence of reflected signal on wavelengths, which defines film thickness.

For irradiation of surface three wavelengths λ₁, λ₂, and λ₃ are used. The wavelengths are selected using following conditions:

$$\frac{{n}_{2} {λ}_{1}}{{λ}_{2}} = 2 \frac{{n}_{2} ( {λ}_{2} )}{{λ}_{2}} ,$$

where n₂ (λ₁) and n₂(λ₂) are refraction coefficients of petrochemical product at the wavelengths: λ₁ and λ₂, λ₃ is wavelength of absorption maximum of petrochemical product. Film thickness is determined using measurement results of reflected signal at these three wavelengths.

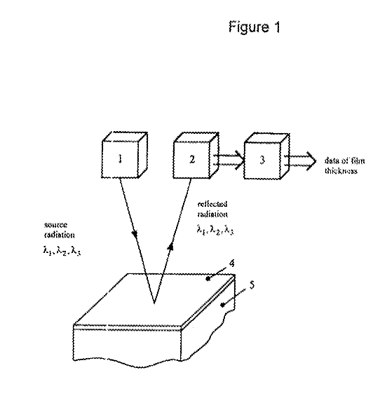

The proposed method can be realized using a device that is shown on the FIG. 1. The device includes a radiation source 1 providing radiation of water surface at three wavelengths λ₁, λ₂, λ₃ selected in a special manner. The device includes a photodetector 2 for radiation registration at three wavelengths, and a processing unit 3 for thickness determination of a film 4 on water surface 5 using measurement results on reflected signal.

The device operates in the following way.

Optical radiation of the source 1 at each wavelength λ₁, λ₂, λ₃ is reflected from the petrochemical film 4 (thickness d) on water surface 5. The photodetector 2 registers intensity of reflected radiation, A signal from detector 2 enters into the processing unit 3 for determination of film thickness d, using measurement results. At flight over investigated water area for the purpose of oil pollution control, the results of the processing unit operation are data array with thickness of the petrochemical film on investigated area.

The photodetector 2 receive radiation powers P(λ₁), P(λ₂) and P(λ₃) reflected from investigated surface at three wavelengths. Each power P(λ₁), P(λ₂) and P(λ₃) can be represented in the following form (see esg. Opto-Electronic Systems of Ecological Monitoring of Environment/V. I. Kozintsev, V. M. Orlov, M. L. Belov, et al. Moscow: Publ. House of BMSTU, 2002-528 p):
P(λ)+AR_{ref}(λ,d),
where:
R_{ref}(λ, d) is the reflection coefficient of three layer system “air-petrochemical film-water” dependent on wavelength λ and on film thickness d;
“A” is the quantity dependent on parameters of radiation source and photodetector, on distance to the surface, on sea surface roughness (at sounding of rough sea surface for example). The quantity A changes slowly (in comparison to R_{ref} (λ, d) with change of radiation wavelength. If the wavelength λ₁ and λ₂ are close to each other then A(λ₁)≅A(λ₂).

The quantity A is not known for certain and is often a random quantity. For example the number of reflecting elements in field of view of the detector and their slopes are random quantity at sounding of rough sea surface.

In the processing unit 3, the following procedures are conducted for elimination of influence of random variation of powers of laser sources and of indetermination of quantity A on measurement results.
the powers P(λ₁), P(λ₂) and P(λ₃) are normalized by output powers Pₛ(λ₁), Pₛ(λ₂) and P₃(λ₃) of the lidar at the wavelengths λ₁, λ₂ and λ₃

$$\tilde{P} ( {λ}_{1 , 2 , 3} ) = \frac{P ( {λ}_{1 , 2 , 3} )}{{P}_{s} ( {λ}_{1 , 2 , 3} )} ;$$
the following relative quantity is calculated

$${C}_{1} = \frac{\tilde{P} ( {λ}_{1} )}{\tilde{P} ( {λ}_{3} )} and {C}_{2} = \frac{\tilde{P} ( {λ}_{2} )}{\tilde{P} ( {λ}_{3} )} .$$

For simplification of the method it is accepted that pulse length and divergence of the lidar are equal at all wavelengths. If this is not the case then differences can be taken into account by processing of received signals

After the described procedures the quantities C₁ and C₂ represent with fine precision the ratio of reflection coefficients of surface at wavelengths λ₁, λ₃ and λ₂, λ₃ correspondingly. At vertical incidence the quantities are determined, taking into account that for oil at λ₃≅3.41 μm, and due to high absorption of oil at wavelength λ₃≅3.41 thickness more than 4-5 μm

$${R}_{ref} ( {λ}_{3} , d ) \approx r \frac{2}{12} ( {λ}_{3} ) - 1$$

(Ye. Gurevich, K. S. Shifrin. Reflection of visible and IR radiation from oil film on sea. Optical method of sea and inland waters study—Novosibrsk: Nauka, 1979.-P. 166-176) by the following equations:

$${C}_{1} ≅ \frac{I}{r \frac{2}{12} ( {λ}_{3} )} - \frac{\begin{matrix}r \frac{2}{12} ( {λ}_{1} ) + r \frac{2}{23} ( {λ}_{1} ) {T}^{2} ( {λ}_{1} ) + \\ 2 {r}_{12} ( {λ}_{1} ) {T}_{23} ( {λ}_{1} ) T ( {λ}_{1} ) cos [ β ( {λ}_{1} , d ) ]\end{matrix}}{\begin{matrix}1 + r \frac{2}{12} ( {λ}_{1} ) + r \frac{2}{23} ( {λ}_{1} ) {T}^{2} ( {λ}_{1} ) + \\ 2 {r}_{12} ( {λ}_{1} ) {r}_{23} ( {λ}_{1} ) T ( {λ}_{1} ) cos [ β ( {λ}_{1} , d ) ]\end{matrix}} \\ {C}_{2} ≅ \frac{I}{r \frac{2}{12} ( {λ}_{3} )} - \frac{\begin{matrix}r \frac{2}{12} ( {λ}_{2} ) + r \frac{2}{23} ( {λ}_{2} ) {T}^{2} ( {λ}_{2} ) + \\ 2 {r}_{122} ( {λ}_{2} ) {r}_{23} ( {λ}_{2} ) T ( {λ}_{2} ) cos [ β ( {λ}_{2} , d ) ]\end{matrix}}{\begin{matrix}1 + r \frac{2}{12} ( {λ}_{2} ) r \frac{2}{23} ( {λ}_{2} ) {T}^{2} ( {λ}_{2} ) + \\ 2 {r}_{12} ( {λ}_{2} ) {r}_{23} ( {λ}_{2} ) T ( {λ}_{2} ) cos [ β ( {λ}_{2} , d ) ]\end{matrix}} \\ where \\ β ( λ , d ) = \frac{2 π d}{λ} {n}_{2} ( λ ) ; T ( λ ) = exp ( - \frac{4 π {k}_{2} ( λ ) d}{λ} ) ; \qquad ( 1 )$$

k₂(λ)—coefficient of absorption of oil product depending on wavelength λ;
r₁₂(λ), r₂₃(λ)—coefficients of reflection on the borders “air-oil fim” and “oil film-water”, depending on wavelength λ and coefficients of refraction and absorption of mediums and not depending on film thickness d (coefficients 1, 2, 3 are related correspondingly to air, oil and water).

The wavelengths λ₁ and λ₂ are selected so that

$$\frac{{n}_{2} ( {λ}_{1} )}{{λ}_{1}} = 2 \frac{{n}_{2} ( {λ}_{2} )}{{λ}_{2}} .$$

With this condition it is obtained that β(λ₁, d)=2β(λ₂, d). This allows for the following expressions for determination of thickness d for thick films:

$$\begin{matrix}\frac{\begin{matrix}{C}_{2} {r}_{12}^{2} ( {λ}_{3} ) A - {r}_{12}^{2} ( {λ}_{2} ) - \\ {r}_{23}^{2} ( {λ}_{2} ) {T}^{2} + 2 {r}_{12} ( {λ}_{2} ) {r}_{23} ( {λ}_{2} ) T\end{matrix}}{{\{ \begin{matrix}{C}_{1} {r}_{12}^{3} ( {λ}_{3} ) [ 1 + {r}_{12}^{2} ( {λ}_{1} ) {r}_{23}^{2} ( {λ}_{1} ) {T}^{W} ] - \\ {r}_{12}^{2} ( {λ}_{1} ) - {r}_{23}^{2} ( {λ}_{1} ) {T}^{W}\end{matrix} \}}^{2}} = \frac{{r}_{12} ( {λ}_{2} ) {r}_{23} ( {λ}_{2} ) [ 1 - {C}_{2} {r}_{12}^{2} ( {λ}_{3} ) ]}{{r}_{12}^{2} ( {λ}_{1} ) {{r}_{23}^{2} ( {λ}_{1} ) [ 1 - {C}_{1} {r}_{12}^{2} ( {λ}_{3} ) ]}^{2}} {T}^{1 - w} \\ where & ( 2 ) \\ T ( {λ}_{2} ) = exp ( - \frac{4 π {k}_{2} ( {λ}_{2} ) d}{{λ}_{2}} ) \\ A = 1 + {r}_{12}^{2} ( {λ}_{2} ) {r}_{23}^{2} ( {λ}_{2} ) {T}^{2} - 2 {r}_{12} ( {λ}_{2} ) {r}_{23} ( {λ}_{2} ) T ; \\ w = \frac{{k}_{2} ( {λ}_{1} ) {n}_{2} ( {λ}_{2} )}{{k}_{2} ( {λ}_{2} ) {n}_{2} ( {λ}_{1} )} ; T = T ( {λ}_{2} ) ; & ( 3 )\end{matrix}$$

T(λ₂)—permeability of film at the wavelength λ₂

Formula (2) contains data of measurements (the quantities C₁ [symbol] C₂), optical constant (r₁₂(λ), r₂₃(λ), W) and quantity T that depends on the thickness of oil film d. By calculating from (2) the quantity T, It is possible to determine the film thickness d.

The above described procedures of determination of the film thickness d operate well when the permeability of the film T is significantly different from one.

Therefore the above method allows, with the use of three specially selected wavelengths, to provide measurements of thickness of thin films when the permeability of the film is significantly different from one, for example oil films with the film thickness more than 4-5 mcm.

The proposed method with the use of three wavelengths λ₁, λ₂, λ₃ selected in a special way allows to determine a film thickness d based on measurement results not only by solving in the processing block (for example with the use of built-in special processor) of non-linear equations of the type (2), (3), but in a simpler way directly from measuring data with the use of a numerical algorithm for determination of d based on the search of a minimum non-connection:
{[C₁−C₁(λ₁, λ₃, d)_{mod}]²+[C₂−C₂(λ₂, λ₃, d)_{mod}]²}^{1/2} (4)
where:
C₁, C₂ are normalized values determined from measuring data at wavelengths λ₁, λ₂, λ₃ (see above);
C₁(λ₁, λ₃, d)_{mod}, C₂ (λ₂, λ₃, d)_{mod} are model quantities of corresponding values that depend on film thickness d (right parts of formula (1)).

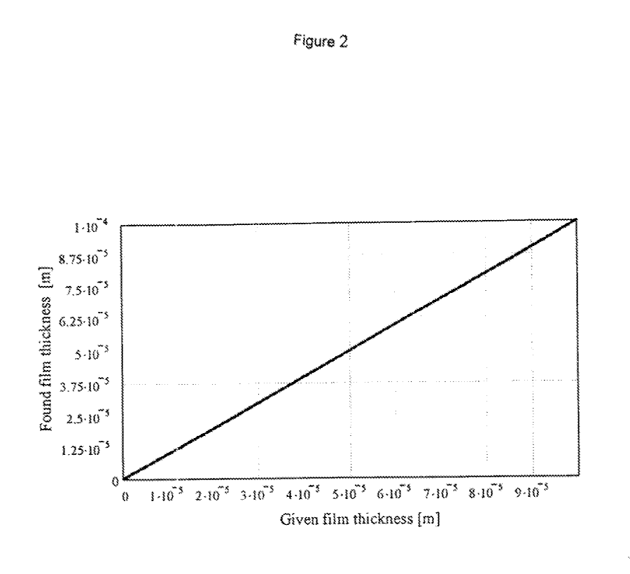

FIG. 2 shows the results of mathematical modeling of operation of a remote method for measurement of thickness of thick oil films on water surface. It shows dependence of the determined value of film thickness (d) which is determined by numerical algorithm (4)) from the value of film thickness given during modeling for a range d≦100 mcm.

The present invention is directed in particular to solve problems of emergency control of thickness of thin oil films in emergency spills of water and oil products on rivers, lakes and sea reservoirs.

It will be understood that each of the elements described above, or two or more together, may also find a useful application in other types of methods and constructions differing from the type described above.

While the invention has been illustrated and described as embodied in a method of and device for thickness of thick petrochemical films on water surfaces, it is not intended to be limited to the details shown, since various modifications and structural changes may be made without departing in any way from the spirit of the present invention.

Without further analysis, the foregoing will fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A method of thickness measurements of thick petrochemical films on a water surface, comprising the steps of irradiating a surface by an optical beam; receiving a reflected signal; analyzing the dependence of intensity of the reflected signal on a wavelength; determining a film thickness based on the analysis; using three wavelengths for irradiation of the surface; selecting the wavelengths from conditions
$$\frac{{n}_{2} {λ}_{1}}{{λ}_{2}} = 2 \frac{{n}_{2} ( {λ}_{2} )}{{λ}_{2}} ,$$
where n₂ (λ₁) and n₂(λ₂) are refraction coefficients of petrochemical product at the wavelengths: λ₁ and λ₂; λ₃ is equal to a wavelength of absorption maximum of petrochemical product; and using for the determination of the film thickness results of the analysis of intensity of the reflected signal at said three wavelengths.

2. A device for measuring thickness of thick petrochemical films on a water surface, comprising means for irradiation of a surface by optical beam; means for receiving a reflected signal; means for analyzing a dependence of intensity of the reflected signal of a wavelength; means for determining a film thickness based on the analysis, wherein said means for irradiation of surface by optical beam is configured as a means for irradiation of surface at three wavelengths selected from conditions; selecting the wavelengths from conditions
$$\frac{{n}_{2} {λ}_{1}}{{λ}_{2}} = 2 \frac{{n}_{2} ( {λ}_{2} )}{{λ}_{2}} ,$$
where n₂ (λ₁) and n₂(λ₂) are refraction coefficients of petrochemical product at the wavelengths: λ₁ and λ₂; λ₃ is equal to a wavelength of absorption maximum of petrochemical product; so that said means for determining a film thickness determine the film thickness using results of the analysis of intensity of the reflected signal at the three wavelengths.
